(19) United States
(12) Patent Application Publication
(10) Pub. No.: US 2026/0078874 A1
(43) Pub. Date: Mar. 19, 2026

(54) STEEL FOR THE TRANSPORT AND STORAGE OF LIQUID AMMONIA

(71) Applicant: GAS AND HEAT S.P.A., Livorno (IT)

(72) Inventors: Mauro EVANGELISTI, Livorno (IT); Marco DI NICOLA, San Giovanni Teatino (IT)

(73) Assignee: GAS AND HEAT S.P.A., Livorno (IT)

(21) Appl. No.: 19/108,699

(22) PCT Filed: Sep. 5, 2023
(86) PCT No.: PCT/IB2023/058751

§ 371 Date: Mar. 4, 2025

(30) Foreign Application Priority Data
Sep. 5, 2022 (IT) 102022000018135

(51) Int. Cl. F17C 3/00; C22C 38/00; C22C 38/58

(52) U.S. Cl. CPC F17C 3/00; C22C 38/001; C22C 38/004; C22C 38/58; F17C 2203/0643; F17C 2221/01; F17C 2221/033; F17C 2223/0161

(57) ABSTRACT

A steel is for making containers, such as for reservoirs or tanks for the storage and transport of liquid ammonia.

### CROSS-REFERENCE TO RELATED APPLICATIONS

The present application is a National Stage Application of PCT International Application No. PCT/IB2023/058751 filed on Sep. 5, 2023, which claims priority to Italian Patent Application 102022000018135, filed with the Italian Patent Office on Sep. 5, 2022, the disclosure of which is incorporated herein by reference in its entirety.

### FIELD OF THE INVENTION

The present invention concerns the use of a special steel for making containers, for example reservoirs or tanks, for the storage and transport of liquid ammonia.

### PRIOR ART

The transport and storage of liquid fuels such as liquefied natural gas (LNG) or liquid ammonia requires the adoption of particular precautions, and the use of specific materials for the construction of containers, reservoirs or tanks dedicated to these operations.

Said containers, in fact, should be able to withstand specific use conditions for each type of fuel, normally very low temperatures and pressures of a few bars to keep the fuels in a liquid state (usually for LNG T=−163° C. and P=3-3.5 bar, and for liquid ammonia T=−33° C. and P=3-3.5 bar), showing at the same time adequate resistance to corrosion under stress. This is both for safety reasons and to guarantee their sufficiently extended use over time.

Said containers should therefore necessarily possess high performance both in terms of mechanical resistance at low temperatures and resistance to corrosion under stress properties, where the latter should also be adequate based on the specific type of liquid fuel transported.

To date, there are specific materials indicated by sector guidelines (IGC-international gas code) for groups of fuels that need to be transported and having, for example, a common specific range of transport temperatures. These guidelines also prescribe additional requirements for some fuels that are more difficult to handle.

The materials known today in the sector are therefore materials specifically intended for use with a specific liquid fuel, for example for use with liquid ammonia or for use with liquefied natural gas (LNG).

This fact, while on the one hand still ensures suitable and specific performance and safe transport and storage conditions for liquid fuels, on the other hand limits the flexibility in storage and transport operations for operators in the sector, preventing the possibility of using the same container to transport, at the same time in separate compartments, or at different times after appropriate washing operations, two different fuels such as LNG and liquid ammonia.

Therefore, containers that can be used to store and transport different fuels are completely absent from the market.

### SUMMARY OF THE INVENTION

The aim of the present invention is to overcome these limits in storage and transport operations flexibility through the possibility of using the same container for the transport and storage of two different liquid fuels, such as LNG and liquid ammonia.

In particular, the Applicant has surprisingly found the possibility of using a steel already known in the sector to be suitable for making containers for the storage and transport of LNG and comprising, by weight percentage, from 15.5 to 17.5% of chromium (Cr), from 6.0 to 8.0% of manganese (Mn), from 3.5 to 5.5% of nickel (Ni), from 0.10 to 0.25% of nitrogen (N), from 0.001 to 0.05% of carbon (C) and from 66.0 to 75.0% of iron (Fe), for making a container for storing or transporting liquid ammonia.

In its first aspect, therefore, the present invention refers to the use of an austenitic stainless steel comprising, by weight percentage, from 15.5 to 17.5% of chromium (Cr), from 6.0 to 8.0% of manganese (Mn), from 3.5 to 5.5% of nickel (Ni), from 0.10 to 0.25% of nitrogen (N), from 0.001 to 0.05% of carbon (C), and from 66.0 to 75.0% of iron (Fe), for making a container for the storage or transport of liquid ammonia.

Said austenitic stainless steel may also include further elements, such as silicon (Si), phosphorus (P), sulfur(S), copper (Cu), titanium (Ti), molybdenum (Mo), and niobium (Nb). In this embodiment, said steel comprises silicon (Si), copper (Cu), titanium (Ti) and molybdenum (Mo) which, individually, have a percent weight concentration lower than or equal to 1.2% by weight.

Preferably said austenitic stainless steel comprises silicon (Si), copper (Cu), titanium (Ti) and molybdenum (Mo) which, individually, have a percent weight concentration lower than or equal to 1.2%, and preferably comprises phosphorus (P) and sulfur(S) which, individually, have a percent weight concentration lower than or equal to 0.06%.

Preferably, said austenitic stainless steel comprises, by weight percentage, from 16.0 to 17.0% of chromium (Cr), from 6.4 to 7.5% of manganese (Mn), from 4.0 to 5.0% of nickel (Ni), from 0.15 to 0.20% of nitrogen (N), and from 0.001 to 0.03% of carbon (C).

Even more preferably, said austenitic steel comprises, by weight percentage, about 16.5% of chromium (Cr), about 7% of manganese (Mn), about 4.7% of nickel (Ni), about 0.15% of nitrogen (N), and 0.025% of carbon (C).

The Applicant has, in fact, surprisingly found that said steel shows mechanical properties and resistance to corrosion towards liquid ammonia properties such as to make it also suitable for the storage and transport of this liquid fuel, in addition to LNG.

In this way, the Applicant has surprisingly understood that it is possible to use the same container for the transport and storage of two different fuels, such as LNG and liquid ammonia.

This entails obvious advantages in terms of containers flexibility of use and transport rationalization for operators in the sector, for example allowing liquid natural gas (LNG) to be transported in the same container at first or in a first compartment, and liquid ammonia at a later time or in a second compartment, thus obtaining a competitive advantage with respect to state-of-the-art transport and storage operations, that would instead require the use of two distinct containers (and two carriers).

In its further aspects, the present invention therefore also relates to a container for use in the storage or transport of liquid ammonia comprising a main body made of austenitic stainless steel as defined in the first aspect of the invention, and wherein said main body comprises at least one joint made with a filler material comprising, by weight percentage, from 15 to 25% of chromium (Cr), from 2 to 4% of molybdenum (Mo), from 14 to 18% of nickel (Ni), from 6 to 8% of manganese (Mn), from 0.13 to 0.20% of nitrogen (N), and from 0.01 to 0.04% of carbon (C), as well as the use of said container for the storage or transport of liquid ammonia.

The container may naturally have any shape, such as for example spherical, cylindrical or bilobed shapes, or other shapes known in the field or in any case designed to contain ammonia.

The advantages of the container and use according to these further aspects of the invention have already been highlighted with reference to the first aspect of the invention and are not repeated here.

Thanks to the properties of the container according to the invention, it is therefore possible to store or transport liquid ammonia, as well as liquid natural gas, with it.

Therefore, in its further aspects, the present invention also refers to a method for storing or transporting liquid ammonia which involves storing or transporting liquid ammonia in said container, as well as to a method for storing or transporting two fuels, of which at least one is liquid ammonia and the other is preferably LNG, comprising the step of simultaneously storing or transporting said two fuels in two separate compartments of the same container, wherein said container is made of an austenitic stainless steel as defined in the first aspect of the invention.

The advantages of the methods according to these further aspects of the invention have also already been highlighted with reference to the first aspect of the invention and are not repeated here.

### BRIEF DESCRIPTION OF THE FIGURES

FIG. 1 shows the image of the 12 specimens used for the Stress Corrosion Testing according to Example 1, of which, specifically, three specimens are without welding (specimens #1 to #3) and nine specimens are with welding (specimens #4 to #12);

FIG. 1A shows the image of two specimens, one without welding (A) and one with welding (B), mounted in the equipment used to carry out the Stress Corrosion Testing of Example 1;

FIGS. 2-13 show the micrographs of the surfaces of specimens #1 to #12 after the Stress Corrosion Testing according to Example 1. Specifically, FIG. 2 shows the micrograph of specimen #1; FIG. 3 shows the micrograph of specimen #4; FIG. 4 shows the micrograph of specimen #5; FIG. 5 shows the micrograph of specimen #6; FIG. 6 shows the micrograph of specimen #2; FIG. 7 shows the micrograph of specimen #7; FIG. 8 shows the micrograph of specimen #8; FIG. 9 shows the micrograph of specimen #9, FIG. 10 shows the micrograph of specimen #3; FIG. 11 shows the micrograph of specimen #10, FIG. 12 shows the micrograph of specimen #11, FIG. 13 shows the micrograph of specimen #12; and

FIGS. 14-19 show the cross-sectional (1/3 (A), 2/3 (B) and 3/3 (C) of through-thickness) and longitudinal (1/3 (A) and 2/3 (B) of through-thickness) tomographies of the surfaces of specimens #6, #8, and #12 after the Stress Corrosion Testing according to Example 1. Specifically, FIG. 14 shows the tomographic scan of specimen #6 cross-sections at (A) 1/3, (B) 2/3 and (C) 3/3 of the through-section; FIG. 15 shows the tomographic scan of specimen #6 longitudinal sections at (A) 1/3, (B) 2/3 of the through-section; FIG. 16 shows the tomographic scan of specimen #8 cross-sections at (A) 1/3, (B) 2/3 and (C) 3/3 of the through-section; FIG. 17 shows the tomographic scan of specimen #8 longitudinal sections at (A) 1/3, (B) 2/3 of the through-section; FIG. 18 shows the tomographic scan of specimen #12 cross-sections at (A) 1/3, (B) 2/3 and (C) 3/3 of the through-section; FIG. 19 shows the tomographic scan of specimen #12 longitudinal sections at (A) 1/3, (B) 2/3 of the through-section.

### DETAILED DESCRIPTION OF THE INVENTION

In its first aspect, the present invention refers to the use of an austenitic stainless steel comprising, by weight percentage, from 15.5 to 17.5% of chromium (Cr), from 6.0 to 8.0% of manganese (Mn), from 3.5 to 5.5% of nickel (Ni), from 0.10 to 0.25% of nitrogen (N), from 0.001 to 0.05% of carbon (C) and from 66.0 to 75.0% of iron (Fe) for making a container for storage or transport of liquid ammonia.

The Applicant has, in fact, surprisingly found that said steel shows mechanical and corrosion resistance properties such as to make it suitable also for the storage and transport of liquid ammonia.

Further advantageous aspects of the method according to the present invention are more extensively detailed in the Summary of the Invention above and are an integral part of the present description, but are not repeated here.

Within the scope of this description and in the subsequent claims, all numerical quantities indicating amounts, parameters, percentages, and so on, are to be intended as preceded in all circumstances by the term “about” unless otherwise indicated. Furthermore, all ranges of numerical quantities include all possible combinations of the maximum and minimum numerical values and all possible intermediate ranges, in addition to those specifically indicated hereinbelow.

The present invention may have in one or more of the aspects thereof one or more of the preferred characteristics reported hereinbelow, which can be combined with each other according to application needs.

Preferably, the austenitic stainless steel according to the present invention comprises, by weight percentage, from 16.0 to 17.0% of chromium (Cr), from 6.4 to 7.5% of manganese (Mn), from 4.0 to 5.0% of nickel (Ni), from 0.15 to 0.20% of nitrogen (N), and from 0.001 to 0.03% of carbon (C), more preferably comprising about 16.5% of chromium (Cr), about 7% of manganese (Mn), about 4.7% of nickel (Ni), about 0.15% of nitrogen (N), and about 0.025% of carbon (C).

Said austenitic stainless steel may further include additional elements, such as silicon (Si), phosphorus (P), sulfur(S), copper (Cu), titanium (Ti), molybdenum (Mo), or niobium (Nb).

Preferably, said steel comprises silicon (Si), copper (Cu), titanium (Ti) and molybdenum (Mo) which, individually, have a percent weight concentration lower than or equal to 1.2% by weight, and preferably comprises phosphorus (P) and sulfur(S), which individually have a percent weight concentration lower than or equal to 0.06% by weight.

More preferably, said steel comprises, by weight percentage, up to 0.75% by weight of silicon (Si) and up to 1.0% by weight of copper (Cu).

Advantageously, said steel comprises, by weight percentage, phosphorus (P) in amounts up to 0.045% by weight, sulfur(S) in amounts up to 0.015% by weight, titanium (Ti) in amounts up to 0.1% by weight, and molybdenum (Mo) in amounts up to 0.75% by weight.

Clearly, the steel according to the present invention also comprises iron (Fe) as a majority component, which preferably is present in amounts ranging from about 66 to about 75% by weight.

In a particularly preferred embodiment, the steel according to the present invention is a steel of the AISI 201LN (USN S20153) type.

The present invention also relates to a container for use in the storage or transportation of liquid ammonia comprising a main body made of an austenitic stainless steel as defined in the first aspect of the invention, and wherein said main body comprises at least one joint made with a filler material comprising, by weight percentage, from 15 to 25% of chromium (Cr), from 2 to 4% of molybdenum (Mo), from 14 to 18% of nickel (Ni), from 6 to 8% of manganese (Mn), from 0.13 to 0.20% of nitrogen (N), and from 0.01 to 0.04% of carbon (C), as well as the use of said container for the storage or transport of liquid ammonia.

The advantages of the container and use according to these further aspects of the invention have already been highlighted with reference to the first aspect of the invention and are not repeated here.

For the purposes of the present invention, the term “container” means any article known to those skilled in the art and suitable for containing a liquid fuel, in this case liquid ammonia.

The container according to the present invention may in fact be of any type known to those skilled in the art for the storage and transport of liquid ammonia, and may for example be a tank, a vessel, or a reservoir.

Furthermore, the container according to the invention may have any shape, such as for example spherical, cylindrical or bilobed shapes, or other shapes known in the sector or in any case designed to contain liquid ammonia.

Furthermore, the container according to the present invention can advantageously be used, positioned, or transported on any carrier or means of transport, for example maritime, road, railway, or air transport.

For example, in one embodiment, the container according to the present invention may be a tank positioned on a tanker.

In an alternative embodiment of the invention, said container may be a tank positioned on a port quay.

The container according to the present invention can also be made according to any production technique known to those skilled in the art for the intended purpose; in particular, as is known, the steel sheets that make up the container are welded together using particular filler materials, in the presence of specific gas mixtures, whose combination is known to those skilled in the art and routinely indicated by those who produce and market the same materials and mixtures.

In the case of the container according to the invention, the latter comprises at least one joint, more preferably all the joints, made with a filler material comprising, by weight percentage, from 15 to 25% of chromium (Cr), from 2 to 4% of molybdenum (Mo), from 14 to 18% of nickel (Ni), from 6 to 8% of manganese (Mn), from 0.13 to 0.20% of nitrogen (N), and from 0.01 to 0.04% of carbon (C).

Preferably, said filler material comprises, by weight percentage, from 20 to 20.5% of chromium (Cr), about 3% of molybdenum (Mo), from 15.5 to 16% of nickel (Ni), from 7 to 7.5% of manganese (Mn), from 0.15 to 0.18% of nitrogen (N), and from 0.015 to 0.03% of carbon (C). The filler material may also advantageously contain further elements, such as for example phosphorus (P), sulfur(S), silicon (Si), molybdenum (Mo), copper (Cu), titanium (Ti), niobium (Nb).

Clearly, the filler material also comprises iron (Fe) as a majority component, which is preferably present in amounts ranging from about 55% to about 63% by weight.

In a preferred embodiment, said filler material is a steel of the AISI 316LMn type.

Thanks to the properties of the container according to the invention, it is possible to store or transport liquid ammonia, as well as liquid natural gas, with it.

Therefore, in its further aspects, the present invention refers to a method for storing or transporting liquid ammonia which involves storing or transporting liquid ammonia in said container, as well as to a method for storing or transporting two fuels, of which at least one is liquid ammonia and the other is preferably LNG, comprising the step of simultaneously storing or transporting said two fuels in two separate compartments of the same container, wherein said container is made of an austenitic stainless steel as defined in the first aspect of the invention. The advantages of the methods according to these further aspects of the invention have also already been highlighted with reference to the first aspect of the invention and are not repeated here.

The invention is now illustrated by some Examples which are intended for illustrative and non-limiting purposes.

### EXPERIMENTAL PART

### Methods

EN ISO 7539-2:1995: Corrosion of metals and alloys-Stress corrosion testing (Part 2: Preparation and use of bent-beam specimens);

EN ISO 7539-1:2012: Corrosion of metals and alloys-Stress corrosion testing (Part 1: General guidance on testing procedures);

EN ISO 7539-8:2008: Corrosion of metals and alloys-Stress corrosion testing (Part 8: Preparation and use of specimens to evaluate weldments);

ISO 16540:2015: Corrosion of metals and alloys-Methodology for determining the resistance of metals to stress corrosion cracking using the four-point bend method;

ASTM B858-06:2018: Standard Test Method for Ammonia Vapor Test for Determining Susceptibility to Stress Corrosion Cracking in Copper Alloys;

UNI EN ISO 6892-1:2020 B: Metallic materials-Tensile testing (Part 1: Method of test at room temperature);

UNI EN ISO 3452-1:2021: Non-destructive testing-Penetrant testing (Part 1: General principles);

### Example 1—Verification of the Compatibility of the AISI 201LN Type for Use with Ammonia Using a Stress Corrosion Testing

12 specimens with the characteristics shown in Table 1 below were made for testing.

TABLE 1

| Specimen | Description |
|---|---|
| #1 | Metal base 3.5 × 15 × 130 mm AISI 201LN steel ASTM |
| | A240- TP 201LN UNS S20153/EN 10028-7: 2007 |
| #2 | Metal base 3.5 × 15 × 130 mm AISI 201LN steel ASTM |
| | A240- TP 201LN UNS S20153/EN 10028-7: 2007 |
| #3 | Metal base 3.5 × 15 × 130 mm AISI 201LN steel ASTM |
| | A240- TP 201LN UNS S20153/EN 10028-7: 2007 |
| #4 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #5 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #6 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #7 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #8 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #9 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #10 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #11 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |
| #12 | Metal base 3.5 × 15 × 130 mm AISI 201LN steel ASTM |
| | A240- TP 201LN UNS S20153/EN 10028-7: 2007 |
| | Filler metal AWS A5.9 ER316 LMn |

Three specimens (#1, #2, and #3) consisted of only a base metal portion, while in the remaining nine (#4-#12) the specimen included a joint having a crossweld with a filler metal at the center of the same specimen. The welding was carried out according to WPS GH101-WPS-6a-0 with 135/GMAW (Gas Metal Arc Welding) process.

Throughout the test, the specimens were loaded and subjected to four-point-bending (FPB) to the minimum yield strength of 310 MPa; Young's modulus was 200 GPa.

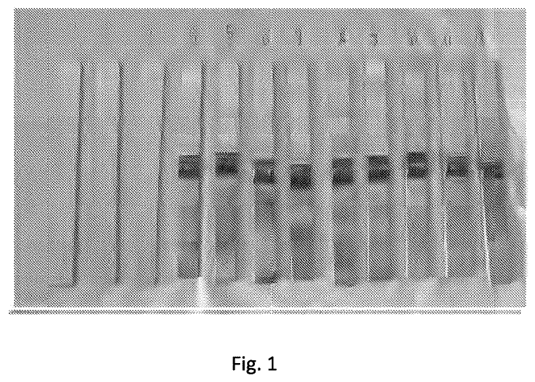

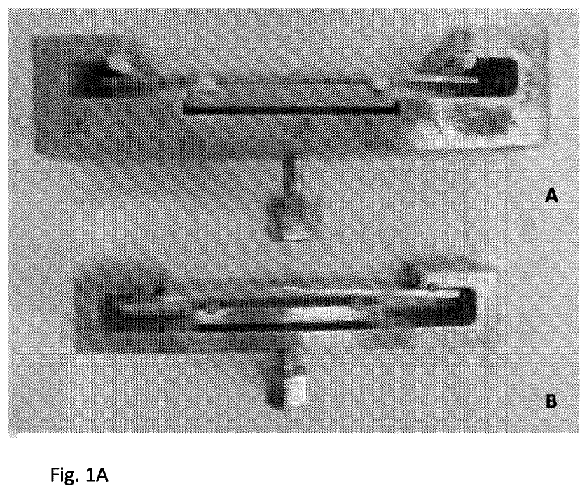

The load was maintained for the entire duration of the test. FIG. 1A shows, as an example, two specimens loaded and bent in this way (with and without welded joint, B and A, respectively).

The test was carried out under three different conditions which represent as much as possible the environmental conditions during the storage and transport of ammonia.
Test #1-Ambient pure ammonia (>99.5%) in gas phase at 25° C. and atmospheric pressure for 720 hours: specimens #1, #4, #5 and #6;
Test #2-Ambient pure ammonia (>99.5%) in gas phase at −20° C. and atmospheric pressure for 720 hours: specimens #2, #7, #8 and #9;
Test #3-Ambient pure ammonia (>99.5%) in liquid phase at −33° C. and atmospheric pressure for 720 hours: specimens #3, #10, #11 and #12.

In each condition, one base material and three welded specimens were therefore kept in the test room.

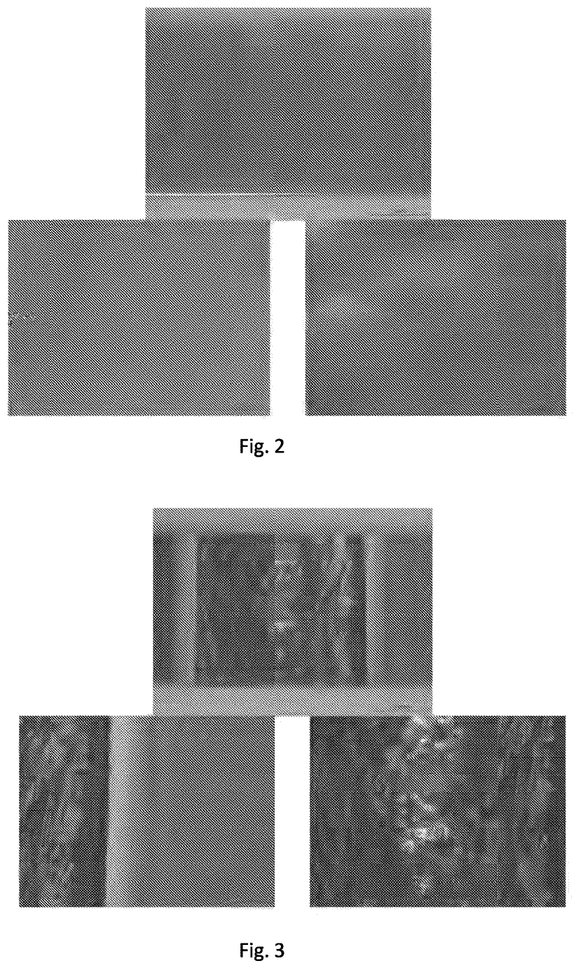

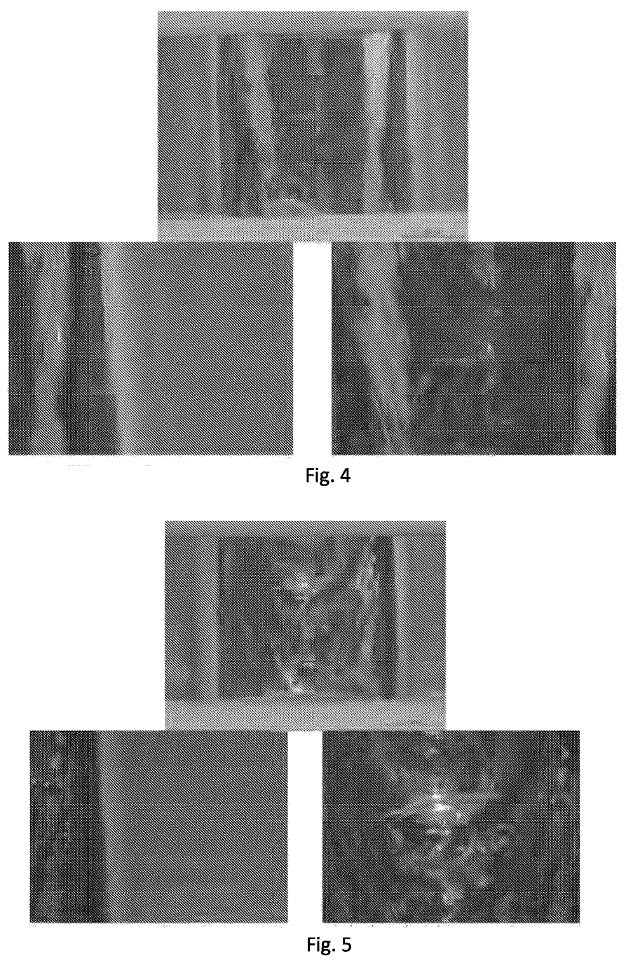

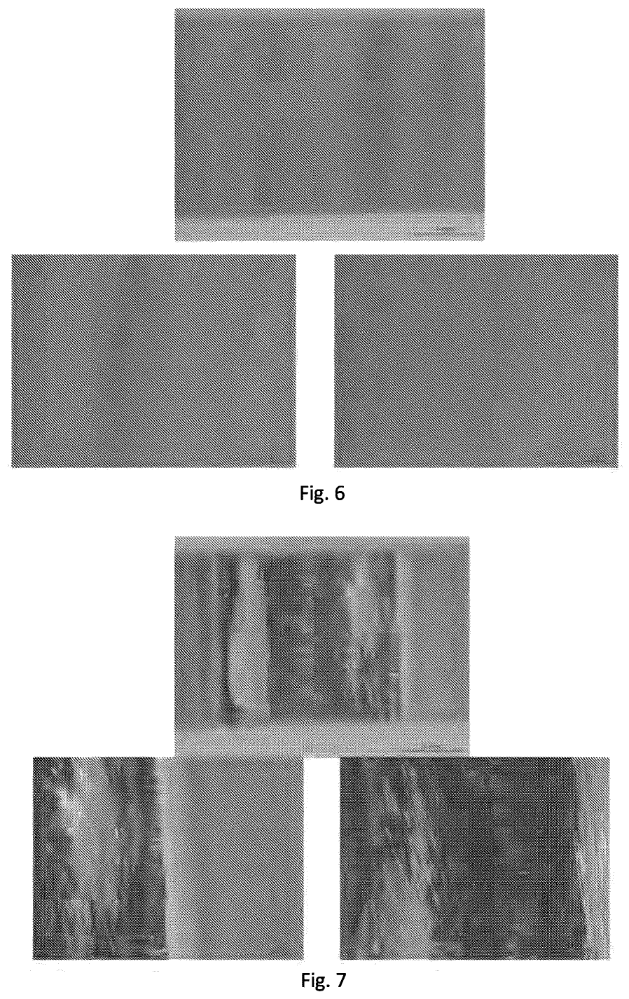

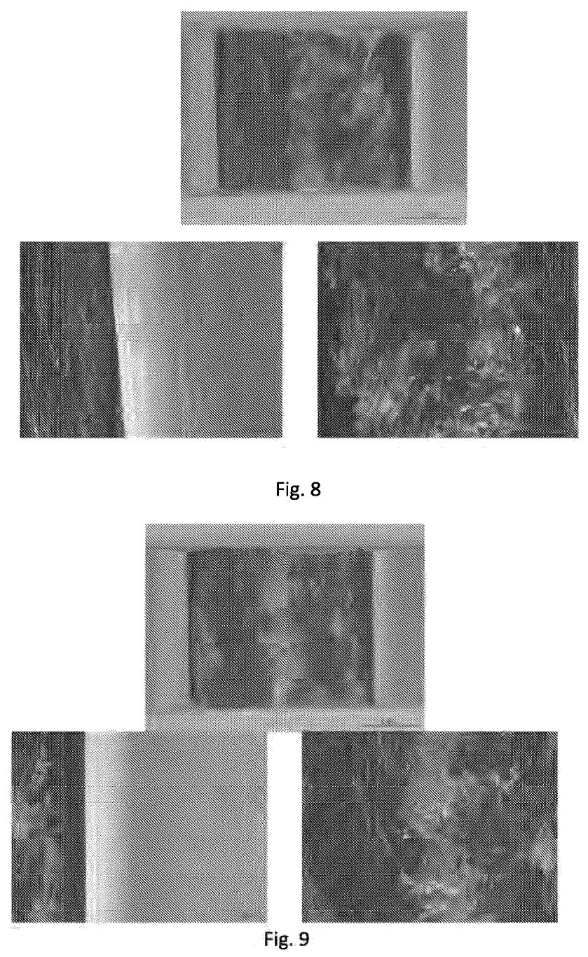

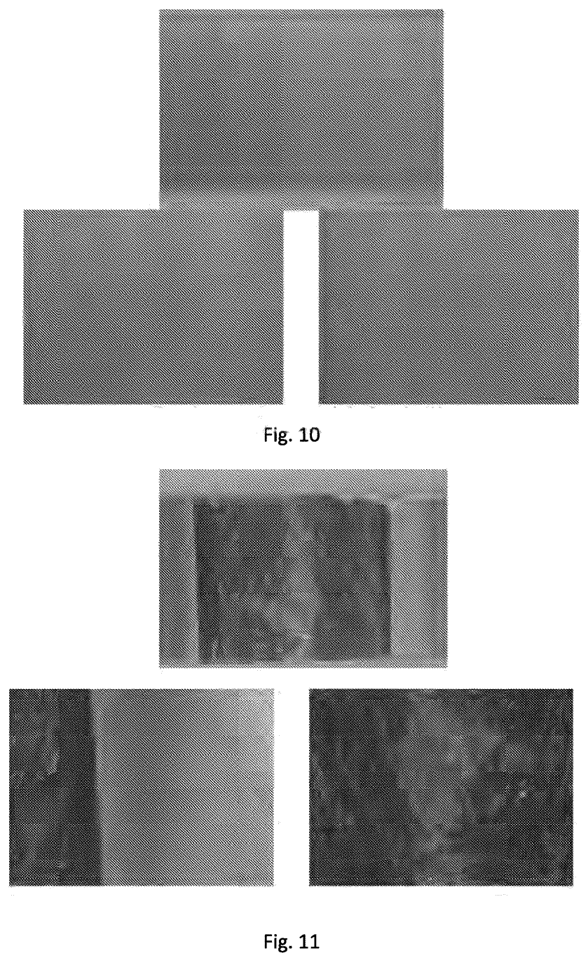

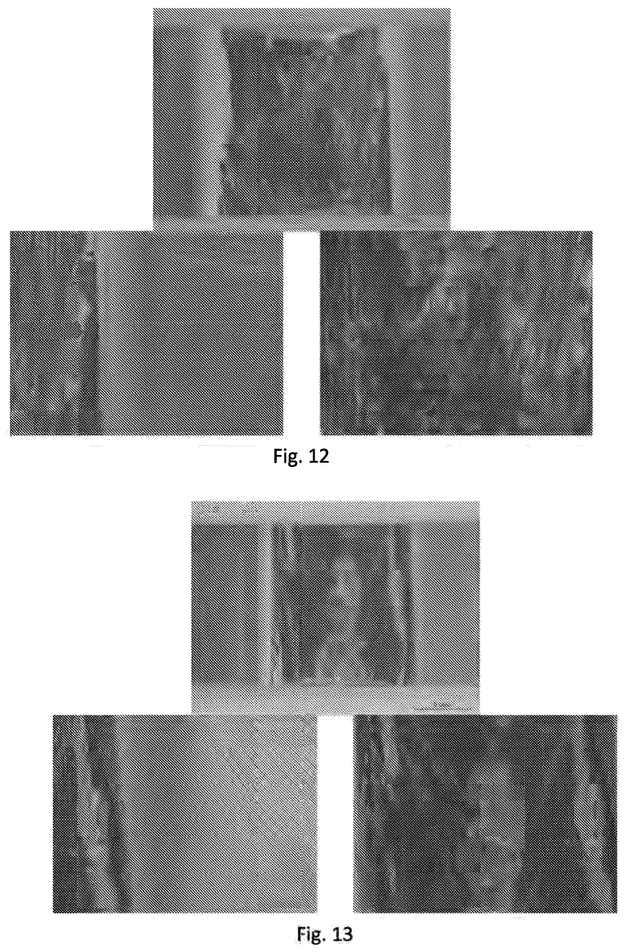

At the end of the testing, the twelve specimens were visually examined with a magnification of at least ×10 using a stereoscopic microscope to detect any visible surface cracks. As a result of the microscopic analyses, none of the specimens revealed the formation of visible surface cracks. FIGS. 2-13 show the micrographs of the surfaces of specimens #1 to #12; the reference scale is shown in the lower right part of each micrograph.

The specimens were then subjected to examination with fluorescent penetrant liquid according to UNI EN ISO 3452-1:2021 level 4 to ensure that no cracks due to the Stress Corrosion Cracking Testing were found on the surface of the specimen.

As a result of the analyses carried out, none of the specimens revealed the formation of cracks resulting from the testing carried out.

Finally, to complete the analyses, a tomographic scan was also performed on a welding specimen for each test condition, to highlight the presence of any cracks inside the specimens. Longitudinal and cross-sections at different depths of the through-thickness were scanned.

The scan parameters are summarized in Table 2 below.

TABLE 2

| Instrument | VTOMEX M300 | |
|---|---|---|
| Voltage/current | 250 kV/100 uA | |
| Filters | 0.5 | mm Sn |
| FOD-FDD | 100.002-808.349 | mm |
| Voxel size | 24.74 | um |
| Timing | 200 | ms |

| | |
|---|---|
| Averaging/skip | 3/1 |
| Sensitivity | 1.0 |
| Images number | 1600 |

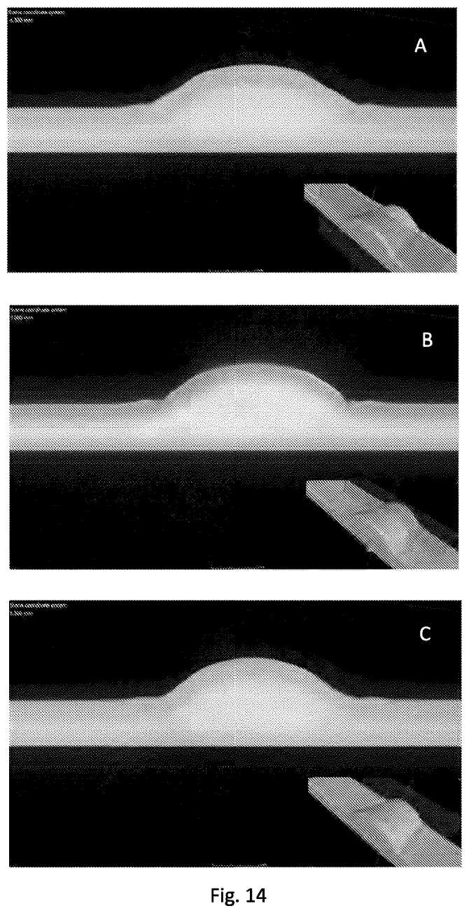

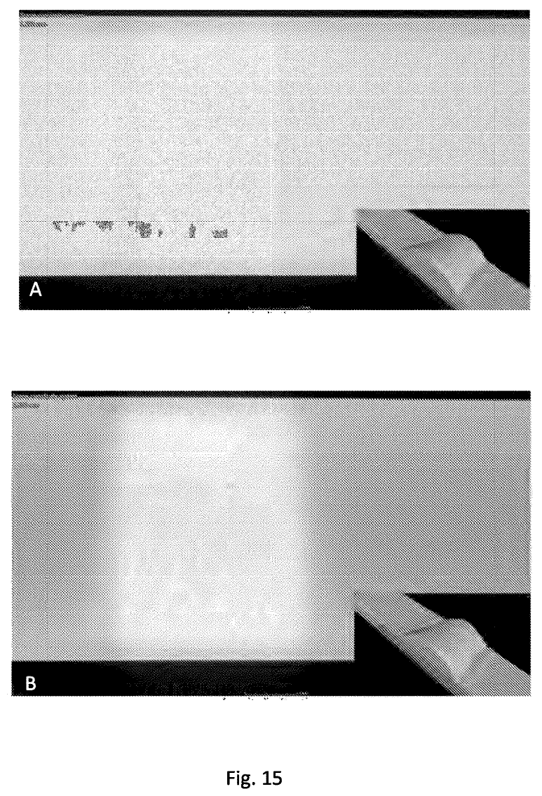

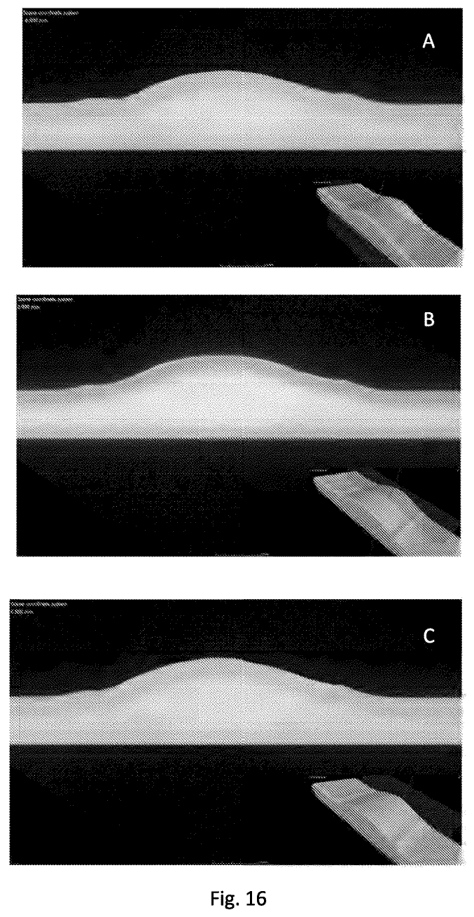

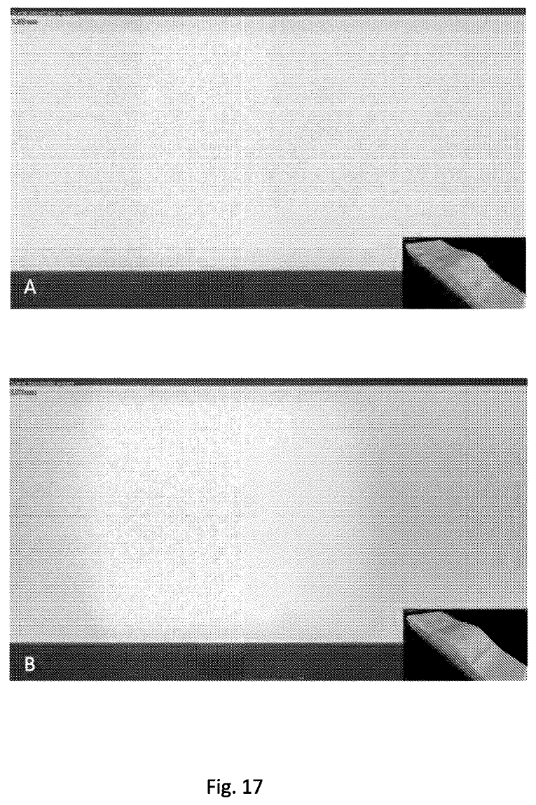

FIGS. 14 and 15 show the cross-sectional (1/3 (A), 2/3 (B) and 3/3 (C) of the through-thickness) and longitudinal (1/3 (A) and 2/3 (B) of the through-thickness) tomographies of the surfaces of specimen #6 after testing under Test #1 conditions).

FIGS. 16 and 17 show the cross-sectional (1/3 (A), 2/3 (B) and 3/3 (C) of the through-thickness) and longitudinal (1/3 (A) and 2/3 (B) of the through-thickness) tomographies of the surfaces of specimen #8 after testing under Test #2 conditions).

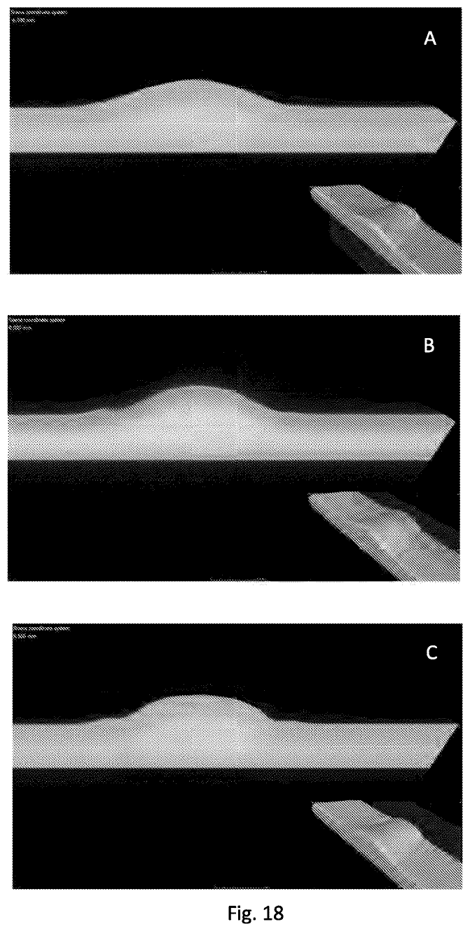

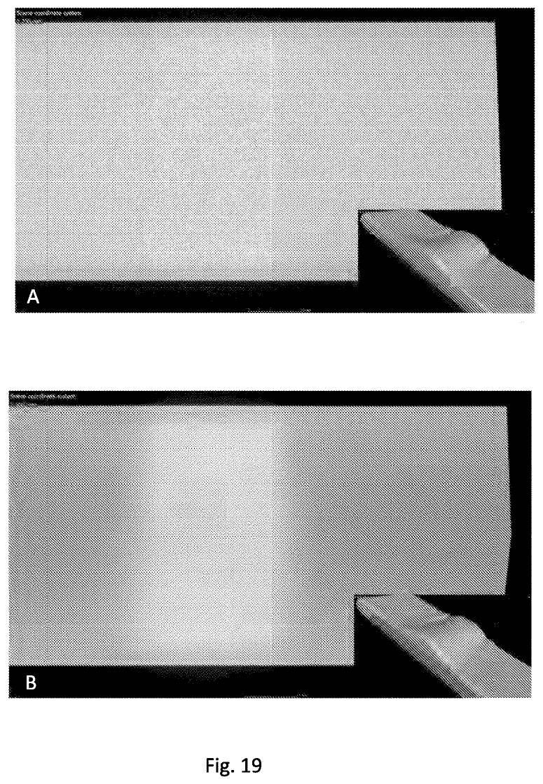

FIGS. 18 and 19 show the cross-sectional (1/3 (A), 2/3 (B) and 3/3 (C) of the through-thickness) and longitudinal (1/3 (A) and 2/3 (B) of the through-thickness) tomographies of the surfaces of specimen #12 after testing under Test #3 conditions).

As a result of the analyses carried out, none of the specimens revealed the formation of cracks inside the specimens.

Therefore, all the tests showed the perfect compatibility of a steel type AISI 201LN for use with liquid ammonia.

1. An austenitic stainless steel for making a container adapted for storage or transport of liquid ammonia, the austenitic steel comprising, by weight percentage, from 15.5 to 17.5% of chromium (Cr), from 6.0 to 8.0% of manganese (Mn), from 3.5 to 5.5% of nickel (Ni), from 0.10 to 0.25% of nitrogen (N), from 0.001 to 0.05% of carbon (C), and from 66.0 to 75.0 of iron (Fe).

2. The austenitic stainless steel according to claim 1, wherein said steel comprises, by weight percentage, from 16.0 to 17.0% of chromium (Cr), from 6.4 to 7.5% of manganese (Mn), from 4.0 to 5.0% of nickel (Ni), from 0.15 to 0.20% of nitrogen (N), and from 0.001 to 0.03% of carbon (C).

3. The austenitic stainless steel according to claim 1, wherein said steel comprises, by weight percentage, about 16.5% of chromium (Cr), about 7% of manganese (Mn), about 4.7% of nickel (Ni), about 0.15% of nitrogen (N), and about 0.025% of carbon (C).

4. The austenitic stainless steel according to claim 1, wherein said steel comprises silicon (Si), phosphorus (P), sulfur(S), copper (Cu), titanium (Ti), molybdenum (Mo), and niobium (Nb).

5. The austenitic stainless steel according to claim 4, wherein said steel comprises silicon (Si), copper (Cu), titanium (Ti) and molybdenum (Mo), which have individually a percent weight concentration lower than or equal to 1.2% by weight.

6. The austenitic stainless steel according to claim 5, wherein said steel comprises, by weight percentage, up to 0.75% of silicon (Si) and up to 1.0% of copper (Cu).

7. The austenitic stainless steel according to claim 4, wherein said steel comprises phosphorus (P) and sulfur(S), which have individually a percent weight concentration lower than or equal to 0.06% by weight.

8. The austenitic stainless steel according to claim 1, wherein said steel is an AISI 201 LN type steel (USN S20153).

9. A container for storage or transport of liquid ammonia comprising a main body made with an austenitic stainless steel comprising, by weight percentage, from 15.5 to 17.5% of chromium (Cr), from 6.0 to 8.0% of manganese (Mn), from 3.5 to 5.5% of nickel (Ni), from 0.10 to 0.25% of nitrogen (N), from 0.001 to 0.05% of carbon (C), and from 66.0 to 75.0 of iron (Fe);
wherein said main body comprises at least one joint made with a filler material comprising, by weight percentage, from 15 to 25% of chromium (Cr), from 2 to 4% of molybdenum (Mo), from 14 to 18% of nickel (Ni), from 6 to 8% of manganese (Mn), from 0.13 to 0.20% of nitrogen (N), and from 0.01 to 0.04% of carbon (C).

10. The container according to claim 9, wherein said filler material comprises, by weight percentage, from 20 to 20.5% of chromium (Cr), about 3% of molybdenum (Mo), from 15.5 to 16% of nickel (Ni), from 7 to 7.5% of manganese (Mn), from 0.15 to 0.18% of nitrogen (N), and from 0.015 to 0.03% of carbon (C).

11. The container according to claim 9, wherein said filler material is an AISI 316LMn type steel.

12. (canceled)

13. A method for storage or transport of liquid ammonia, comprising the step of storing or transporting liquid ammonia in a container made of the austenitic stainless steel as defined in claim 1.

14. A method for storage or transport of two fuels, wherein at least one fuel is liquid ammonia, comprising the step of simultaneously storing or transporting said two fuels in two separate compartments of the same container, wherein said container is made of the austenitic stainless steel as defined in claim 1.
